(19) United States
(12) Patent Application Publication
(10) Pub. No.: US 2017/0316388 A1
(43) Pub. Date: Nov. 2, 2017

(54) Systems and Methods for Use in Evaluating Automated Clearing House (ACH) Transactions

(71) Applicant: MASTERCARD INTERNATIONAL INCORPORATED, Purchase, NY (US)

(72) Inventors: Ganesh L. Iyer, Chesterfield, MO (US); Debra Meade, Bedford, TX (US); Leslie Chrapek, Foristell, MO (US); Srinivasarao Nidamanuri, Chesterfield, MO (US); Christopher W. Jennings, Wentzville, MO (US); Pamela Rabaino, Wildwood, MO (US); Ellen Vlaytchev, Chesterfield, MO (US); Sudheer Nandhi, Chesterfield, MO (US)

(21) Appl. No.: 15/335,657

(22) Filed: Oct. 27, 2016

Related U.S. Application Data
(60) Provisional application No. 62/329,649, filed on Apr. 29, 2016.

(51) Int. Cl. G06Q 20/02; G06Q 20/40

(52) U.S. Cl. CPC G06Q 20/023; G06Q 20/405

(57) ABSTRACT

Systems and methods are provided for use in evaluating automated clearing house (ACH) transactions, in connection with determining whether to post or return the transactions. One exemplary method includes receiving, at a computing device, a batch file including multiple ACH transactions and segregating, by the computing device, each of the ACH transactions. The method then includes, for each of the multiple segregated transactions, evaluating the transaction, by the computing device, relative to a first rule and directing, by the computing device, the transaction to a workbasket for human review when the transaction violates the first rule whereby the ACH transaction is submitted for human review rather than returning the ACH transaction upon the violation of the first rule.

### CROSS-REFERENCE TO RELATED APPLICATION

This application claims the benefit of, and priority to, U.S. Provisional Application No. 62/329,649 filed on Apr. 29, 2016. The entire disclosure of the above application is incorporated herein by reference.

### FIELD

The present disclosure generally relates to systems and methods for use in evaluating Automated Clearing House (ACH) transactions that are sent via an ACH formatted file, and in particular, relates to evaluating ACH transactions, for example, based on ACH association rules and appropriate program guidelines, etc., to determine in real time (or near real time) whether to automatically post, return, or manually review the ACH transactions.

### BACKGROUND

This section provides background information related to the present disclosure which is not necessarily prior art.

Automated Clearing House (ACH) transactions generally permit originating financial institutions to deposit and/or withdraw funds to/from accounts, based on permissions from account holders associated with the accounts. Such ACH transactions are often used, for example, to fund transactions involving utility bills, tax bills, and other bills via bill pay applications, and to deposit funds associated with directly deposited wages and tax refunds (among others). Typically, the ACH transactions are directed to one of two ACH networks (e.g., FedACH, Electronic Payments Network (EPN), etc.), which in turn directs the transactions to receiving entities. The receiving entities then credit and/or debit the funds for the ACH transactions, as appropriate, to and/or from the account holders' accounts. The funds are later cleared and settled among the financial institutions. Fees are often associated with the ACH transactions.

Separately, payment account transactions (e.g., credit card transactions, etc.) involving consumers and merchants are known to involve transaction messages. The transaction messages are typically generated by the merchants and are communicated through payment networks to issuers of payment accounts involved in the transactions. The issuers reply to the messages, generally within seconds of the underlying transactions, either approving or declining the transactions. When the transactions are approved, funds are directed to the merchants by the issuers, through clearing and settlement, and the consumers are subsequently billed for their transactions.

### DRAWINGS

The drawings described herein are for illustrative purposes only of selected embodiments and not all possible implementations, and are not intended to limit the scope of the present disclosure.

FIG. 1 is an exemplary system of the present disclosure suitable for use in evaluating Automated Clearing House (ACH) transactions;

FIG. 2 is a block diagram of a computing device that may be used in the exemplary system of FIG. 1; and

FIG. 3 is an exemplary method, which may be implemented in connection with the system of FIG. 1, for evaluating ACH transactions based on one or more rules associated with one or more entities.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Automated Clearing House (ACH) transactions are often used, as desired, to deposit funds to accounts (e.g., funds relating to direct deposits, funds associated with tax refunds, etc.) and to debit funds from accounts (e.g., funds used in bill pay applications, funds associated with tax bills, etc.). Such ACH transactions are typically compiled into batch files by originating financial institutions (where the transactions are received), and the batch files are then forwarded to an ACH network multiple times per day, or more or less, for processing. In connection therewith, the ACH transactions are then routed, by the ACH network, to appropriate receiving entities, which determine whether to post the transactions or return the transactions (e.g., back to the originating financial institutions, etc.). The determination to post or return the transactions is typically a batch process and often takes a day or more depending on time and date of receipt (as well as filing posting date). In addition, the determination to return some of the ACH transactions may be the result of un-locatable or wrong account information, lack of available funds, and/or criteria unintended and/or inapplicable to the underlying transactions or the account holders involved in the transactions. As can be appreciated, determinations to return transactions may involve different time frames based, for example, on the particular reasons to return the transactions (e.g., where the different time frames for the different return reasons may be defined by the ACH network, etc.).

Uniquely, the systems and methods herein provide for evaluating the ACH transitions prior to posting to accounts. In particular, the ACH transactions, after being compiled into batch files by the originating financial institutions (broadly, originating entities), are received by an ACH engine, which segregates the transactions and evaluates the transactions against various configurable rules, either specific to a particular program (e.g., a prepaid program, etc.) and/or to the account holders (or groups of account holders) involved in the transactions, or generic to all involved parties. When the ACH transactions meet one or more of the configurable rules, they may be accepted and posted, or they may be routed to workbaskets for human intervention and/or review, or they may be returned. In this manner, the evaluation of the ACH transactions occurs before an ACH posting file is received, thereby providing a mechanism for acceptance and/or review of the transactions prior to subsequent return determinations by the receivers, and thereby reducing the number of returned transactions. As such, a greater percentage of transactions will be posted (and included in the posting file) rather than returned, while also addressing and reducing the risk and/or exposure of posting improper transactions to the accounts. In addition, an opportunity for account segmentation is provided, in which account holders in different segments (individually or as a group) can be affected differently by the systems and methods herein.

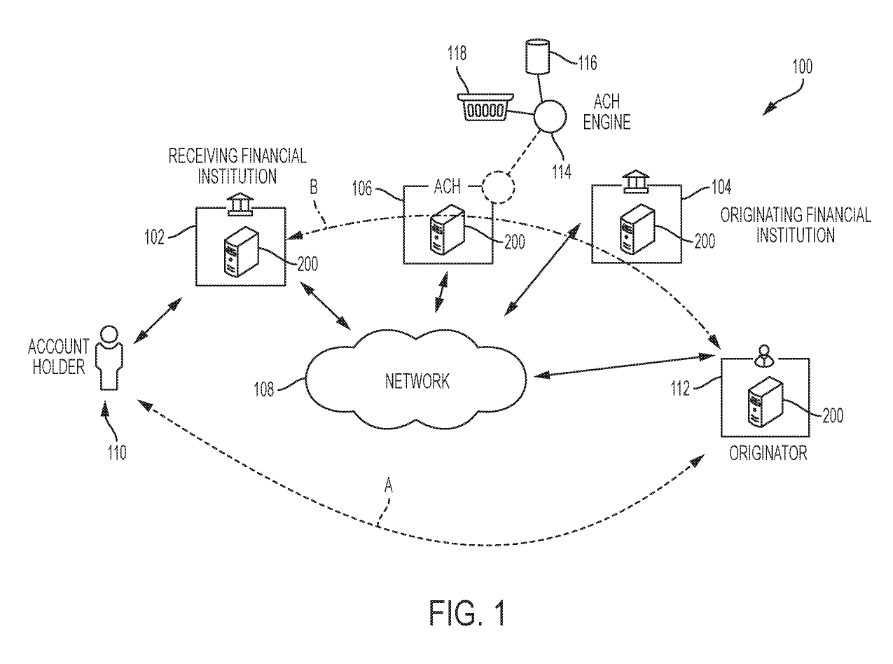

FIG. 1 illustrates an exemplary system 100, in which the one or more aspects of the present disclosure may be implemented. Although the system 100 is presented in one arrangement, other embodiments may include the parts of the system 100 (or other parts) arranged otherwise depending on, for example, a number of entities involved in ACH transactions in the system 100, etc.

As shown in FIG. 1, the illustrated system 100 generally includes depository financial institutions 102, 104 (broadly, entities) and an ACH operator 106, each coupled to and in communication with network 108. The ACH operator 106 is configured to process ACH transactions in the system 100 that flow between different depository financial institutions, for example, the institutions 102, 104. While the system 100 is illustrated and described herein as including the depository financial institutions 102, 104 between which ACH transactions flow, it should be appreciated that the system 100 and the various embodiments herein are not limited to financial institutions and, in fact, may include other entities (e.g., prepaid program managers, etc.) between which ACH transactions flow.

The network 108 in the system 100 may include, without limitation, a local area network (LAN), a wide area network (WAN) (e.g., the Internet, etc.), a mobile network, a virtual private network, and/or another suitable public and/or private network capable of supporting communication among two or more of the parts illustrated in FIG. 1, or any combination thereof. For example, the network 108 may include multiple different networks, such as a private transaction network made accessible by the ACH operator 106 to the financial institutions 102, 104 and, separately, the public Internet, which may be accessible to an account holder 110 or a transaction originator 112, as well as other parts of the system 100, etc., as desired.

The account holder 110 in the system 100 is associated with an account (e.g., a prepaid account, another account to which ACH transactions may be directed, etc.), which is issued by the financial institution 102. Likewise, the originator 112 is associated with an account, which is issued by the financial institution 104.

The account holder 110 and the originator 112, in this exemplary embodiment, are involved in a relationship through which the account holder 110 (broadly, a receiver in the following examples) has granted permission, subject to certain conditions, to the originator 112 to debit and/or deposit funds from/to the account holder's account. For example, the originator 112 may be a utility provider (e.g., a gas provider, an electric provider, a telecommunications provider, etc.), and the account holder 110 may be a subscriber/customer that receives the utility. To fund (or pay for) the utility, the account holder 110 then provides permission for the originator 112 to debit funds for payment for the utility (e.g., fixed or variable amounts, etc.) from the account holder's account, as indicated by path A in the FIG. 1, each week, month, or some other regular or irregular interval of service, etc. As another example, the originator 112 may be a government entity associated with taxation, and the account holder 110 may be a taxpayer that granted permission for the originator 112 to deposit a tax refund to the account holder's account. With that said, it should be appreciated that the above examples are non-limiting in nature, and that a variety of different ACH transactions may be initiated by the originator 112 (and/or by the account holder 110) to transfer funds to and/or from the account associated with the account holder 110.

In an example transaction, the originator 112 (with permission from the account holder 110) initiates an ACH transaction to the account holder's account as a debit transaction, for example, to fund the next month of utility service provided by the originator 112. In connection therewith, the ACH transaction is transmitted, consistent with path B in FIG. 1, to the financial institution 104 (hereinafter, also referred to as the originating financial institution 104), which then forwards the ACH transaction to the ACH operator 106. In particular, upon receipt of the ACH transaction from the originator 112, the originating financial institution 104 compiles it into a batch file with tens, hundreds, thousands, etc. of other ACH transactions (e.g., formatted according to National Automated Clearing House Association (NACHA) operating rules and guidelines, etc.), which is then transmitted to the ACH operator 106 (e.g., on a periodic basis by which the originating financial institution 104 transmits such batch files to the ACH operator 106, etc.). Each ACH transaction in the batch file includes, for example (and without limitation), a routing number and an account number for the account associated with the account holder 110, a routing number and an account number for the account associated with the originator 112, an amount associated with the ACH transaction, a time and date of the transaction, and a currency type. Upon receipt of the ACH transactions in the batch file, and based on the data included in each of the ACH transactions, the ACH operator 106 communicates, as is conventional, each of the individual ACH transactions to the respective receiving entities (subject to any prior evaluation, in accordance with the present disclosure and as described hereinafter). Specific to this example, the ACH operator 106 communicates the ACH transaction involving the account holder 110 (originating from the originator 112) to the financial institution 102 (hereinafter, also referred to as the receiving financial institution 102). The amount of the ACH transaction is then debited from the account holder's account (e.g., by or at the direction of ACH engine 114, etc.). The transaction is later cleared, and the funds are settled between the financial institutions 102, 104 through the ACH operator 106.

While a single account holder 110 and a single originator 112 are illustrated in the system 100 in FIG. 1, it should be appreciated that multiple ones of these parts may be included in the system 100 in other embodiments. In addition, while the account holder 110 is illustrated as a person in FIG. 1, it should be appreciated that the account holder 110 may include groups of persons, business entities, institutions, corporations, companies, partnerships, organizations, etc. Likewise, while the originator 112 is described as a merchant herein, the originator may include one or more persons, groups of persons, business entities, institutions, corporations, companies, partnerships, organization, etc. Generally, however, as used herein, the originator 112 is the originator of an ACH transaction, and the account holder 110 is the receiver (or recipient) of the ACH transaction (whether involving a credit or a debit to the account holder's account).

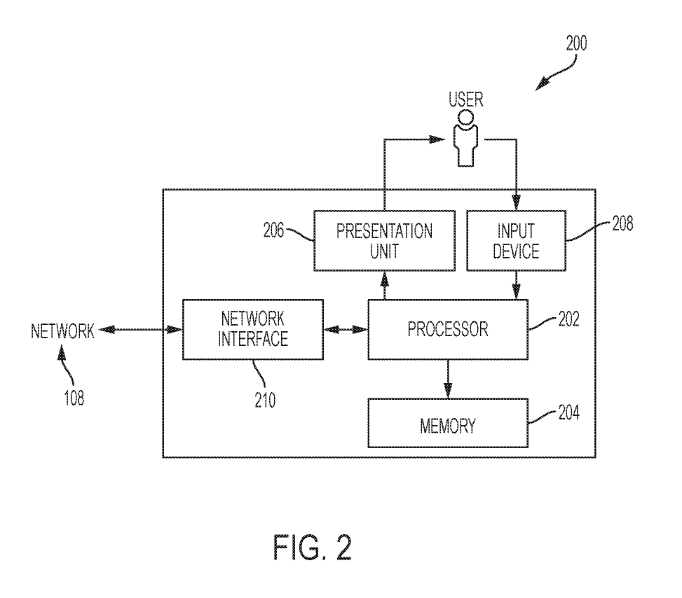

FIG. 2 illustrates an exemplary computing device 200 that can be used in the system 100. The computing device 200 may include, for example, one or more servers, workstations, computers, laptops, tablets, smartphones, etc. In addition, the computing device 200 may include a single computing device, or it may include multiple computing devices located in close proximity or distributed over a geographic region, so long as the computing devices are configured to function as described herein. In the system 100, each of the financial institutions 102, 104, the ACH operator 106, and the originator 112 are illustrated as including, or being implemented in, computing device 200 coupled to (and in communication with) the network 108. However, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the operations described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, account data for account holders and originators, ACH transaction data, workbasket data structures, batch files, rules, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein.

In the exemplary embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information (e.g., workbasket interfaces, etc.), visually, for example, to a user of the computing device 200, such as a user associated with the financial institution 102 in the system 100, a user associated with the financial institution 104, a user associated with the ACH operator 106, the account holder 110, a user associated with ACH engine 114, a user associated with rules data structure 116, and/or a user associated with workbasket data structure 118, etc. Various interfaces (e.g., as defined by network-based applications, etc.) may be displayed at computing device 200, and in particular at presentation unit 206, to display certain information, as described herein. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

In addition, the computing device 200 includes an input device 208 that receives inputs from the user of the computing device 200 (i.e., user inputs) such as, for example, instructions to return or post ACH transactions, etc. The input device 208 is coupled to (and is in communication with) the processor 202 and may include, for example, one or more of a keyboard, a pointing device, a mouse, a stylus, a card reader, another data or symbol reader (for reading data or other symbols as referenced herein), a camera, a touch sensitive panel (e.g., a touch pad or a touch screen, etc.), another computing device, and/or an audio input device. Further, in various exemplary embodiments, a touch screen, such as that included in a tablet, a smartphone, or similar device, may behave as both a presentation unit and an input device.

The illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 108. Further, in some exemplary embodiments, the computing device 200 includes the processor 202 and one or more network interfaces incorporated into or with the processor 202.

Referring again to FIG. 1, the system 100 includes the ACH engine 114, which is configured, often by executable instructions, to operate as described herein. For example, among other things, the engine 114 is configured to evaluate ACH transactions in the system 100, as described herein, prior to the ACH operator 106 forwarding the transaction along. The engine 114 is illustrated as a standalone device in the system 100, separate from the ACH operator 106. However, as indicated by the dotted lines in FIG. 1, the engine 114 may be incorporated and/or integrated with, in whole or in part, the ACH operator 106 (or one or more different ACH operators) in other system embodiments. It should be appreciated that the ACH engine 114 may be considered a computing device, or may be implemented in a computing device, consistent with computing device 200.

In addition to the ACH engine 114, the system 100 includes the rules data structure 116 and the workbasket data structure 118, both of which are stored in memory such as, for example, memory 204 of the engine 114, etc. While the data structures 116, 118 are illustrated as separate parts of the system 100, it should be appreciated that in some embodiments they may be included together as a single data structure (e.g., in memory 204, etc.). Further, in general, the data structures 116, 118 are implemented in combination with the engine 114, such that the data structures 116, 118 are included in the system 100, or variations thereof, with the engine 114.

The rules data structure 116 includes one or more rules employed by the ACH engine 114 to determine whether to post, return or review an ACH transaction. The rules may be provided by and/or associated with any one or more of the receiving financial institution 102, the originating financial institution 104, the account holder 110, the originator 112, another part of the system 100 (shown or not shown), etc. For example, an ACH transaction that is to be posted, based on an employed rule, is transmitted to a corresponding receiving entity for final review and posting. An ACH transaction that is to be returned, based on an employed rule, is transmitted back to an originating entity. And, an ACH transaction that is to be reviewed (rather than automatically returned) (e.g., when at least some information in the ACH transaction is not correct, etc.), based on an employed rule, is transmitted to the workbasket data structure 118 (e.g., for human review, etc.). The rules data structure 116 may include rules in an “if-then” format, and/or it may include rules in other formats, and/or in a prescribed disposition of the transaction (e.g., post, review, return, alter, etc.). In addition, the rules in the data structure 116 may be generic to multiple different entities, or they may be specific to particular entities, segments of account holders and/or originators, and/or individual account holders and/or originators, etc. Further, the rules may apply to various different aspects of the ACH transaction including, for example, a transaction load limit, matching of the account owner's name in the transaction to a name of the associated account (or part thereof), a status of the account owner's account (e.g., open, active, etc.), a permitted overdraft percentage, etc.

As an example, the rules in the data structure 116 may relate to load limits for ACH transactions, and may provide actions to be taken by the ACH engine 114 if the load limits are exceeded. In addition, different entities (e.g., financial institutions, etc.) may have different rules relating to the load limits. What's more, some entities may allow (or require) load limits to be overridden for loads over a predefined limit. In connection therewith, in the exemplary system 100, the receiving financial institution 102 (broadly, a receiving entity) may have a rule that defines a daily load limit of $500 for the account associated with the account holder 110. In addition, the rule may specify that the daily load limit can be overridden for the account holder 110 up to $600. This rule may apply to all accounts associated with the receiving financial institution 102, or it may apply to particular segments of account holders (with the different segments then having different load limits). In contrast, another entity (e.g., another financial institution, another entity, etc.) in the system 100 (not shown) may have a rule that defines a daily load limit of $700 for all accounts associated therewith, with no override instructions. In both cases, the rules may allow ACH transactions to post if the daily load limit is satisfied (taking into account any override instructions), but may specify the transaction to be returned when the daily load limit is violated.

As another example, the rules in the data structure 116 may relate to account holder names included in the ACH transactions. Here, the receiving financial institution 102 may have a rule that requires the name of the account holder 110, as included in the ACH transaction, to match the name of the account holder 110 on the account holder's account. Via the rule, the match may be limited to a certain number of letters such as, without limitation, the first three letters of the first name and the first 12 letters of the last name (e.g., Barbara Smith matching Barb Smith, etc.). Again, the rules may then allow ACH transactions to post if the names match, but may specify the transactions to be either returned to originating entities (e.g., originating financial institution 104, originator 112, etc.) when the names do not match or transmitted to the workbasket data structure 118 for human review.

As still another example, the rules may relate to overdraft percentages for ACH transactions. In connection therewith, the receiving financial institution 102 may have a rule that defines a permitted overdraft percentage (e.g., <5 percent, etc.) for the account holder 110, or for certain segments of account holders for which the account holder 110 is a member. If the ACH transaction includes an overdraft percentage greater than the permitted percentage, the transaction may be returned. Alternatively, the receiving financial institution 102 may have a rule that defines tiered overdraft percentages, and particular actions to be taken by the ACH engine 114 for each tier. A first tier may define a permitted overdraft percentage (e.g., <5 percent, etc.) for which ACH transactions are to be posted; a second tier may define a review overdraft percentage (e.g., 5-10 percent, etc.) for which ACH transactions are to be transmitted to the workbasket data structure 118 for human review; and a third tier may define a return over draft percentage (e.g., >10 percent, etc.) for which ACH transactions are to be returned to originating entities.

As a further example, the rules may relate to formats of account indicia included in ACH transactions. The receiving financial institution 102 may have a rule that defines an acceptable format for the account of the account holder 110 to include a routing number for the receiving financial institution 102 and an account number for the account. If an ACH transaction includes a different format of account indicia, for example, a card account number of a prepaid card associated with the consumer's account (e.g., a card plastic account number, etc.), the rule may specify that the ACH engine 114 automatically allow acceptance of the card account number when present rather than the account number for the account provided to the account holder 110 with the routing number.

As another example, the rules in the data structure 116 may relate to notification of successful and/or failed ACH transactions (e.g., loads and unloads, etc.). For example, the financial institution 102 may have a rule that instructs the ACH engine 114 to notify the account holder 110 (e.g., via email, SMS, etc.) of successful and/or failed ACH transactions involving his/her account. Similarly, the financial institution 104 may have a rule that instructs the ACH engine 114 to notify the originator 112 of successful and/or failed ACH transactions involving the originator's account.

As still another example, the rules in the data structure 116 may relate to validating accounts prior to posting ACH transactions (e.g., prior to loading and/or unloading accounts on file, etc.). For example, the financial institution 102 may have a rule that instructs the ACH engine 114 to verify the account associated with the originator 112 prior to posting an ACH transaction thereto from the account associated with the account holder 110.

It should be appreciated that the above rules are exemplary in nature, and that the rules data structure 116 may include the same or different rules for use as described herein, depending on, for example, financial institutions, ACH operators, account holders, originators, and/or other entities involved in ACH transactions.

With continued reference to FIG. 1, initially in the system 100, the ACH engine 114 is configured to communicate with the financial institutions 102, 104 to obtain (and store in a data structure, as needed or desired) account information specific to the financial institutions 102, 104 and/or to the account holder 110. The account information may include, without limitation, account names, account balances and/or status, account segments (e.g., platinum, gold, silver, etc.), overdraft limits, load limits, parallel account numbers (e.g., primary account numbers (PANs), etc.), etc. Some account information for the financial institutions 102, 104 and/or for the account holder 110 may be obtained by the ACH engine 114 from the ACH transaction, where certain account information is included with the transaction. In addition, some account information, for example, relating to overdraft limits, load limits, etc., may relate to particular rules associated with the engine 114 (in the rules data structure 116).

In connection with the example ACH transaction described above (involving the account holder 110), the ACH engine 114 is configured to receive the batch file including the ACH transaction at or in parallel with the ACH operator 106. The engine 114 is configured to then evaluate the ACH transaction (as well as the other ACH transactions in the batch file) against one or multiple rules in the rules data structure 116. Based on the evaluation (e.g., based on whether or not the ACH transaction violates the one or multiple rules, etc.), the engine 114 is configured to either direct the ACH transaction to the receiving financial institution 102 to be posted, return the ACH transaction to the originating financial institution 104, or direct the ACH transaction to the workbasket data structure 118 for human review (e.g., in lieu of simply returning the ACH transaction to the originating financial institution 104, etc.).

Further, in some implementations, the engine 114 may be configured to accept the ACH transaction when it does not meet posting rules (instead of directing the ACH transaction to be returned or directing the ACH transaction to the workbasket data structure 118), so that the transaction can still be expeditiously posted.

As an example, if the ACH transaction received by the ACH engine 114 from the originating financial institution 104 includes a primary account number (PAN) for a payment card associated with the account holder's account, instead of a traditional account number for the actual account (e.g., a pseudo-PAN/DDA, etc.), the ACH transaction may conventionally be returned. Herein, the rules data structure 116 may instead include a rule that instructs the ACH engine 114 to verify that the PAN is associated with the account and, if it is, cause the ACH transaction to be posted. The ACH engine 114 may then include a rule, in the rules data structure 116, that allows the ACH engine 114 to accept future ACH transactions with the PAN and allow the transactions to post (without subsequently verifying the PAN each time). In addition, in such future ACH transactions including the PAN, the ACH engine 114 may optionally replace the PAN with the account number for the account (e.g., perform an auto PAN swap, etc.), and then communicate the modified ACH transaction to the receiving financial institution 102 to be posted.

In addition, the ACH engine 114 may be configured to permit changes to the rules and/or exceptions to the rules (e.g., one-time use rules (e.g., load limit overrides, etc.), etc.) by the account holder 110 and/or the originator 112. For example, an employer (broadly, an originator) may plan to issue bonuses to employees (broadly, account holders or receivers). However, amounts of the bonuses violate daily load limits for the accounts of at least some of the employees. Conventionally, the employer has the option to send multiple ACH transactions, potentially on different days, and incurring a separate cost for each. In the system 100, however, the engine 114 is configured to provide one or more interfaces to the employer, or otherwise receive a request from the employer, to append a load limit override for each employee (more specifically, the employees' accounts) (individually or by account range, for example) to the rules data structure 116. Consequently, when the ACH transactions for the employees are received at the ACH engine 114, the engine 114 is configured to apply the appended rule and permit deposit of the bonuses in one ACH transaction for each employee.

In another application, an account holder or an originating entity may request a rule to post an ACH transaction prior to a settlement date for the transaction. For example, if the account holder 110 falls into a preferred status (based on a status of his/her payment account, for example), and the ACH engine 114 receives an ACH transaction to deposit funds to the account holder's account (e.g., a tax return, etc.) on a particular future date, the ACH engine 114 may post that transaction on the day it is received instead of on the future date.

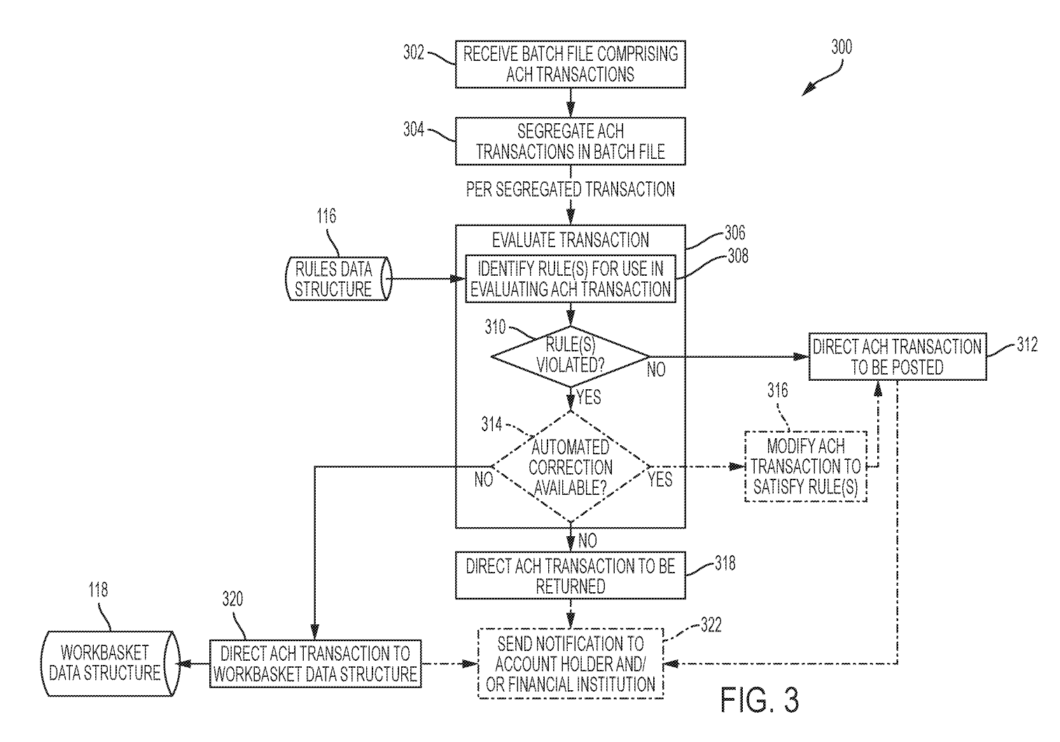

FIG. 3 illustrates an exemplary method 300 for use in evaluating ACH transactions, in accordance with the present disclosure. The method 300 is described with reference to an ACH transaction initiated by the originator 112 in the system 100 to debit funds from the account associated with the account holder 110, based on permission from the account holder 110, and also with reference to the ACH engine 114 and the data structures 116, 118. The method 300 is further described with reference to computing device 200. It should be appreciated, however, that the methods herein are not limited to the system 100 and the computing device 200, and that the systems and computing devices herein are not limited to method 300. And, while described with reference to a debit transaction, the description herein is generally applicable to deposit transactions as well.

In the illustrated method 300, the originating financial institution 104 accumulates ACH transactions from multiple originators (including the ACH transaction from the originator 112) and compiles them in a batch file. At desired times (e.g., one to six times daily, at other intervals, etc.), the originating financial institution 104 then communicates the batch file to the ACH operator 106 (or directly to the ACH engine 114, depending on where the ACH engine 114 is implemented, for example, along path B in system 100). In turn, the ACH engine 114 receives the batch file, at 302 (e.g., in parallel to the ACH operator 106, at the ACH operator 106, etc.), and the multiple ACH transactions in the batch file. The engine 114 then segregates the multiple ACH transactions in the batch file, at 304. The individual ACH transactions, once segregated, may then be stored in a data structure, as desired, in preparation for being evaluated by the engine 114, as described hereinafter.

Next, the ACH engine 114 evaluates each of the segregated ACH transactions from the received batch file individually (in parallel or in sequence). For one of the transactions, the engine 114 evaluates, at 306, the ACH transaction initiated by the originator 112 in the system 100 to debit funds from the account associated with the account holder 110. Evaluation of other ones of the segregated ACH transactions is similarly performed by the engine 114, as indicated above, in parallel or in sequence.

In particular, as part of evaluating the ACH transaction, the ACH engine 114 initially identifies, at 308, a rule (or multiple rules), from the rules data structure 116, against which the ACH transaction is to be evaluated. The rules may be identified, for example, based on the financial institution(s) 102, 104 involved in the transaction, the account holder 110, and/or the originator 112, etc. For example, the identified rule(s) may be particular to the receiving financial institution 102 (which is associated with the account of the account holder 110), to the originating financial institution 104 (which is associated with the originator 112 that initiated the transaction), to the account holder 110, and/or to the originator 112. In addition, the rule(s) may relate to any desired aspect of the ACH transaction. Further, the engine 114 may identify, at 308, certain, more general, rules based on a type of the account issued to the account holder 110 (e.g., which defines a type of payment card issued to the account holder 110, etc.), a segment of the account relative to other segments, or otherwise. Specifically, for example, the receiving financial institution 102 may issue accounts as gold accounts, platinum accounts, and diamond accounts (broadly, by segment). The rules identified by the engine 114 may then be different by segment, such that, for example, a diamond account may have a higher load limit than a gold account, etc.

Once the rule(s) is/are identified, the ACH engine 114 then determines whether the ACH transaction (e.g., the data included in the transaction, etc.) satisfies the rule, at 310. If the rule is satisfied, the engine 114 directs the ACH transaction to be posted, at 312. For example the engine 114 may transmit the ACH transaction (often in combination with other ACH transactions to be posted, as a batch posting file) to the receiving financial institution 102 to be posted (e.g., via the ACH operator 106, etc.). Often, this may be done as an outbound batch posting file, including multiple other ACH transactions to be posted and involving accounts at the receiving financial institution 102. In particular, the posting file is posted, via network-based messaging (e.g., online messaging, etc.), to the receiving financial institution 102 (e.g., again, via the ACH operator 106, etc.), which, in turn, validates and/or verifies the transactions included therein. It should be appreciated, however, that merely directing the ACH transaction to the receiving financial institution 102 (as part of the posting file) to be posted does not guarantee that the ACH transaction will be posted, as the receiving financial institution 102 may still perform one or more validations and/or verifications of the ACH transaction and/or the account of the account holder 110 associated with the transaction. When indicated, returns are then transmitted within a time interval (e.g., several hours, a day, intervals as specified by the ACH operator 106 per return type, etc.) to the ACH operator 106. The ACH operator 106 is then able to schedule to pass the return transactions back to the originating financial institution 104, the originator 112, and/or the account holder 110, etc., as appropriate.

Conversely, if the ACH engine 114 determines that one or more rules are not satisfied (i.e., violated) (at 310), the engine 114 then may optionally determine (as indicated by the broken lines in FIG. 3), at 314, whether an automated correction is available (or applicable) for the ACH transaction. Some rule violations, for example, may involve minor errors in the ACH transaction or may involve errors that have previously been manually reviewed but are persistent in subsequent transactions, and may therefore involve low risk if posted (and, optionally, corrected). As such, depending on the rule that is violated, the engine 114 may potentially (as again indicated by the broken lines) correct (or alter) the ACH transaction, at 316, to address the rule violation and allow the ACH transaction to proceed to post. Once altered or modified (if no other violations exist), the engine 114 directs, at 312, the altered ACH transaction to be posted to the receiver's account (as described above).

As an example, if the ACH transaction received by the ACH engine 114 from the originating financial institution 104 includes a PAN for a payment card for the account associated with the account holder 110, instead of the actual account number for the account, the ACH transaction may violate one of the applied rules from the rules data structure 116 (e.g., a rule associated with the receiving financial institution 102, etc.). In response, the engine 114, upon accessing the account information for the account, may automatically replace the PAN with the account number for the account (and/or other information pertaining to the account), at 316, and then direct the altered/modified ACH transaction to the receiving financial institution 102 to be posted. Alternatively, upon identifying the ACH transaction including the PAN, ACH engine 114 may generate a new rule (or a rule exception) that specifically allows future ACH transactions including the PAN to post. Then, in connection therewith, the ACH engine 114 may simply include the ACH transaction in a batch posting file, or the ACH engine 114 may first modify the ACH transaction to include the account number instead of the PAN.

When a rule is determined to be violated (at 310), but automatic correction of the violation (at 314) is not applicable (or if it is optionally not performed/implemented), the ACH engine 114, depending on the rule that is violated, either directs the ACH transaction to be returned to the originating financial institution 104, at 318, or directs the ACH transaction to the workbasket data structure 118, at 316, for further human review.

The disposition of the ACH transaction is often based on the rule violated (with some rules resulting in automatic return at 318, and other rules resulting in review at 320 rather than automatic return). Specifically, for example, the rule may define a permitted overdraft percentage for the account holder 110 of less than 25 percent. Here, if the ACH transaction involves an overdraft amount that is less than the 25 percent threshold, the ACH engine 114 directs the transaction to the workbasket (at 320) for further human review. However, if the ACH transaction involves an overdraft amount that is greater than the 25 percent threshold, the engine 114 directs the transaction to be returned to the originating financial institution 104 (at 318). As another example, if the account holder 110 is being reviewed for one or more various sanction checks (which may conventionally result in return of an ACH transaction), a case may be open for human review for ACH transactions involving the account holder 110 (e.g., a disposition of the ACH transactions to the workbasket data structure 118, at 316), so that the transactions can still be posted.

In connection with directing the ACH transaction to the workbasket data structure 118 (at 320), the ACH engine 114 is associated with one or multiple users who access the workbasket data structure 118, through one or more workstations (e.g., consistent with computing device 200, etc.) and review the transaction. Through such review, the one or multiple users make a determination as to whether to post the ACH transaction (e.g., transmit the transaction to the receiving financial institution 102, etc.) or to return the ACH transaction to the originating financial institution 104. As part of the review, the users may approve the transaction (and allow posting) or return the transaction to the originating financial institution 104. In various embodiments, if review of the ACH transaction in the workbasket data structure 118 is not implemented by the users (or is incomplete) within a predefined interval or time period (e.g., thirty minutes, one hour, two hours, four hours, twelve hours, one day, etc.), the ACH engine 114 may automatically return the transaction to the to the originating financial institution 104 (or, alternatively, may automatically post the transaction (e.g., append the transaction to a posting file), for example, depending on instructions from one or more of the receiving financial institution 102 involved and the originating financial institution 104 involved, etc.).

With continued reference to FIG. 3, optionally in the method 300 (as indicated by the dotted lines), when the ACH engine 114 directs the ACH transaction to be returned to the originating financial institution 104 or when the ACH transaction is directed to the workbasket data structure 118 (and/or when the transaction is returned following such human review), the engine 114 may transmit a notification to the account holder 110 and/or the originator 112 of the ACH transaction, at 322. The account holder 110 and/or the originator 112 can then attempt to correct the ACH transaction, and resubmit it. Or, the account holder 110 and the originator 112 can identify alternative forms of payment, as necessary. It should be appreciated that the notification may be transmitted via any desired means including, for example, SMS, email, etc.

It should be appreciated that the above evaluation, etc., by the ACH engine 114, is performed for each of the segregated transactions in the batch file received from the originating financial institution 104 and/or other originating entities. In at least one embodiment, however, certain transactions and/or originating entities may be excluded from the evaluation and/or may opt out of such evaluation by the engine 114.

In addition, it should also be appreciated that the systems and method herein are generally applicable to any accounts to which ACH transactions may be directed. For example, in various embodiments, the systems and methods herein may be directed to prepaid accounts. While in other embodiments, the systems and methods herein may be directed to other suitable accounts (e.g., debit accounts, etc.).

In view of the above, the systems and methods herein permit ACH transactions to be evaluated prior to the transactions being posted, so that the risk and/or exposure of the ACH transactions may be reduced. In particular, various rules are implemented into the evaluation, whereby an ACH engine makes determinations as to whether the transactions should be posted, returned, reviewed, or altered (prior to being posted). The rules may be specific, defined and/or requested, by various entities (e.g., financial institutions, etc.), account holders, and/or originators, thereby providing flexibility in the efficient evaluation of ACH transactions (e.g., per segment of accounts, etc.). The evaluation provided herein may further limit and/or reduce the number of ACH transactions that are retuned, unintentionally and/or improperly by specific errors and/or unwanted application of certain criteria (e.g., relating to load limits, overdraft protection, etc.) thereby increasing the efficiency of the processing of the ACH transactions (and increasing the number/percentage of ACH transactions posted).

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transforms a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by: (a) receiving a batch file including multiple ACH transactions; (b) segregating each of the ACH transactions; and (c) for each of the multiple segregated transactions: (i) evaluating the transaction relative to a first rule; (ii) directing the transaction to a workbasket for human review based on the first rule, whereby the ACH transaction is submitted for human review rather than returning the ACH transaction based on the first rule; (iii) causing a user to view the ACH transaction in the workbasket, and then returning the ACH transaction in response to a user input indicating the ACH transaction is in violation of the first rule; (iv) evaluating the transaction relative to a second rule; (v) directing the transaction to be returned to an originating financial institution when the transaction violates the second rule; (vi) evaluating the transaction relative to a third rule; and (vii) modifying the transaction based on the third rule, and directing the modified transaction to be posted.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements/features recited in the claims are intended to be a means-plus-function element within the meaning of 35 U.S.C. §112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in evaluating Automated Clearing House (ACH) transactions, the method comprising:
receiving, at a computing device, a batch file including multiple ACH transactions;
segregating, by the computing device, each of the ACH transactions; and
for each of the multiple segregated ACH transactions:
evaluating the transaction, by the computing device, relative to a first rule; and
directing, by the computing device, the transaction to a workbasket for human review based on the first rule, whereby the ACH transaction is submitted for human review rather than returning the ACH transaction based on the first rule.

2. The computer-implemented method of claim 1, further comprising, for each of the multiple segregated transactions, causing a user to view the ACH transaction in the workbasket, and then returning the ACH transaction in response to a user input indicating the ACH transaction is in violation of the first rule.

3. The computer-implemented method of claim 1, wherein the first rule is specific to a financial institution associated with an account to which the ACH transaction is directed.

4. The computer-implemented method of claim 3, wherein the first rule is further based on a type of account to which the ACH transaction is directed.

5. The computer-implemented method of claim 1, further comprising, for each of the multiple segregated transactions:
evaluating the transaction, by the computing device, relative to a second rule; and
directing, by the computing device, the transaction to be returned to an originating financial institution when the transaction violates the second rule;
wherein directing the transaction to a workbasket includes directing the transaction to the workbasket when the transaction violates the first rule, but not the second rule.

6. The computer-implemented method of claim 1, further comprising, for each of the multiple segregated transactions:
evaluating, by the computing device, the transaction relative to a third rule; and
modifying the transaction based on the third rule, and directing the modified transaction to be posted.

7. The computer-implemented method of claim 1, wherein the first rule relates to at least one of an account name and/or an account status.

8. The computer-implemented method of claim 1, wherein directing the transaction to a workbasket for human review includes directing the transaction to the workbasket for human review when at least one piece of data in the transaction is incorrect.

9. The computer-implemented method of claim 1, wherein the transaction is a first transaction that is posted following the human review, and wherein the first transaction is directed to the workbasket based on incorrect data included in the transaction; and
further comprising modifying the first rule and/or generating a second rule for the receiver's account in response to the human review of the first transaction, the modified first rule and/or the second rule allowing acceptance of a second transaction to the receiver's account including the same incorrect data as included in the first transaction.

10. A non-transitory computer-readable storage medium including computer executable instructions for evaluating automated clearing house (ACH) transactions, which, when executed by a processor, cause the processor to:
receive a batch file including multiple ACH transactions;
evaluate at least one of the multiple ACH transactions from the batch file, relative to multiple rules;
direct the at least one of the multiple ACH transactions to be returned when a first one of the multiple rules is violated; and
direct the at least one of the multiple ACH transactions to a workbasket for human review when a second one of the multiple rules is violated, rather than automatically returning the at least one of the multiple ACH transactions for violation of the second one of the multiple rules.

11. The non-transitory computer-readable storage medium of claim 10, wherein the computer executable instructions, when executed by the processor, further cause the processor to:
alter the at least one of the multiple ACH transactions when a third one of the multiple rules is violated; and
direct the altered at least one of the multiple ACH transactions to be posted when none of the other multiple rules are violated.

12. The non-transitory computer-readable storage medium of claim 11, wherein the computer-executable instructions, when executed by the processor, cause the processor, in order to alter the at least one of the multiple ACH transactions, to replace a primary account number (PAN) for a payment card associated with an account identified in the at least one of the multiple ACH transactions with at least a routing number and/or an account number associated with the account.

13. The non-transitory computer-readable storage medium of claim 10, wherein the first one of the multiple rules includes a required match between at least a portion of a name included in the at least one of the multiple ACH transactions and a name associated with an account holder of an account identified in the at least one of the multiple ACH transactions.

14. The non-transitory computer-readable storage medium of claim 10, wherein the computer executable instructions, when executed by the processor, further cause the processor to send a notification to an account holder associated with an account identified in the at least one of the multiple ACH transactions when the first one and/or the second one of the multiple rules is violated.

15. The non-transitory computer-readable storage medium of claim 10, wherein the computer executable instructions, when executed by the processor, further cause the processor to direct the at least one of the multiple ACH transactions to be posted when the at least one of the multiple ACH transactions includes a load in excess of a load limit, but a third one of the multiple rules includes a load limit override.

16. A system for use in evaluating Automated Clearing House (ACH) transactions, the system comprising:
a computing device coupled to a receiving financial institution and an originating financial institution, the computing device including:
at least one processor; and
a non-transitory storage memory including executable instructions defining an ACH engine, which when executed by the at least one processor, cause the at least one processor to:
receive a batch file including multiple ACH transactions from the originating financial institution;
evaluate at least one of the multiple ACH transactions from the batch file relative to multiple rules, a first rule of the multiple rules associated with a type of an account involved in the at least one of the multiple ACH transactions; and
direct the at least one of the multiple ACH transactions to a workbasket for human review when the first rule is violated, rather than posting the at least one of the multiple ACH transactions to the receiving financial institution and/or returning the at least one of the multiple ACH transactions to the originating financial institution.

17. The system of claim 16, wherein the executable instructions, when executed by the at least one processor, further cause the at least one processor to direct the at least one of the multiple ACH transactions to be returned when a second one of the multiple rules is violated, in lieu of transmitting the at least one of the multiple ACH transaction to the receiving financial institution.

18. The system of claim 17, wherein a second rule of the multiple rules is associated with transactions including a primary account number (PAN) for a payment card for the account to which the at least one of the multiple ACH transactions is directed instead of a traditional account number for the account; and
wherein the executable instructions, when executed by the at least one processor, cause the at least one processor to:
evaluate the at least one of the multiple ACH transactions from the batch file relative to the second rule;
verify that the PAN is associated with the account, when the second rule is violated; and
modify the second rule and/or generate a third rule allowing acceptance of a second one of the multiple ACH transitions to the account when the second one of the multiple ACH transactions includes the same PAN instead of the traditional account number for the account.

19. The system of claim 17, wherein the second rule of the multiple rules includes a required match between at least a portion of a name included in the at least one of the multiple ACH transactions and a name associated with an account holder of the account identified in the at least one of the multiple ACH transactions.

20. The system of claim 17, wherein the executable instructions, when executed by the at least one processor, further cause the at least one processor to:
append the at least one of the multiple ACH transactions to a posting file, when a predefined interval after directing the at least one of the multiple ACH transactions to the workbasket expires and the human review is incomplete, and when the second rule is not violated; and
direct the posting file to the receiving financial institution.
